(19) United States
(12) Patent Application Publication
(10) Pub. No.: US 2009/0277071 A1
(43) Pub. Date: Nov. 12, 2009

(54) FISHING LURE

(75) Inventor: Paul F. Harris, JR., Ladson, SC (US)

Correspondence Address: HAMMER & ASSOCIATES, P.C., 3125 SPRINGBANK LANE, SUITE G, CHARLOTTE, NC, 28226, US

(73) Assignee: Z-Man Fishing Products, Inc.

(21) Appl. No.: 12/118,790

(22) Filed: May 12, 2008

(51) Int. Cl. A01K 85/00

(52) U.S. Cl. 43/42.24; 43/42.53; 43/42.32

(57) ABSTRACT

A method of creating a fishing lure comprising the steps of: providing a lure body having a head end, a tail end, and a slot at the head end. Providing dumbbell eyes which comprise a pair of eye shaped members interconnected by an elastic member. The dumbbell eyes are then inserted into the slot of said lure body.

### FIELD OF THE INVENTION

The instant invention relates to fishing lures and more specifically to eyes used in fishing lures.

### BACKGROUND

A fishing lure is a bait; especially an artificial one, used in fishing. Many different types of bodies are available for fishing lures. Most of these bodies are made of rubber, silicon or plastisol. Plastisol is combination of polyvinyl chloride (PVC) mixed with a plasticizer. Bodies are often molded in the shape of the animals which the fish, which one desires to catch, usually will pray upon. Examples of these body shapes include lizards, bugs, worms, grubs, frogs, fish, eels, mud dogs, salamanders, crayfish, shrimp and the like. Colors run the full gambit of the spectrum and may be bright, translucent, dark, florescent or glow in the dark. The bodies may include shiny flakes or translucent colors may be combined with contrasting flake colors. The body may also be a combination of feathers, scales, fur, rubber skirts and other materials.

One very important component of many fishing lures are the eyes. A variety of eyes are available within the fishing lure industry. Adhesive lure eyes are very common and are simply adhered to the side of a fishing lure body/head. Adhesive lure eyes may be in the form of a sticker or in the form of a molded piece of hard plastic. These adhesive eyes may work reasonably well on rigid fishing lure bodies or heads, but they perform very poorly when used as a component for soft, flexible fishing lures. The flexibility and movement of the soft lures breaks the adhesive bond between the eye and the lure body/head during normal use, and especially during a strike from a fish, resulting in a loss of one or both eyes and decreased effectiveness of the fishing lure. Dumbbell eyes have long been used as components of fishing lures by lure manufacturers and fly fishermen. Assembly of the dumbbell eyes into the fishing lure is faster and less expensive than gluing individual eyes on both sides of the lure. Dumbbell eyes are more secure than glued-on surface eyes, and provide weight and a jigging motion to the lure. Dumbbell eyes are also available in a variety of colors and sizes. However, dumbbell eyes are constructed of hard plastic or metal making them rigid and hard.

There is a need for an improved fishing lure having dumbbell eyes that are flexible, stretchable, and which can conform to the size and shape of the lure in which they are being used in order to ensure that they will remain in place while in use.

### SUMMARY OF THE INVENTION

A method of creating a fishing lure comprising the steps of: providing a lure body having a head end, a tail end, and a slot at the head end. Providing dumbbell eyes which comprise a pair of eye shaped members interconnected by an elastic member. The dumbbell eyes are then inserted into the slot of said lure body.

### BRIEF DESCRIPTION OF THE DRAWINGS

FIG. 1 is a side view of a fishing lure showing an empty slot.

FIG. 2 is a side view of a fishing lure showing a pair of dumbbell eyes inserted into a slot.

FIG. 3 a pair of dumbbell eyes.

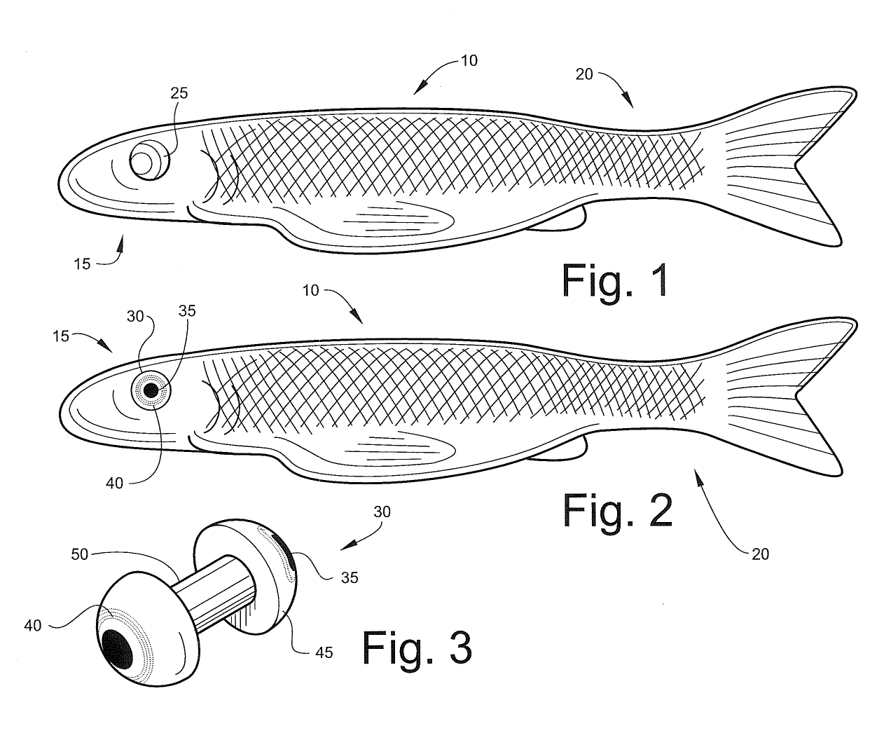

### DETAILED DESCRIPTION OF THE INVENTION

The present invention includes a method of creating a fishing lure 10 which comprises the steps of providing a lure body having a head end 15, a tail end 20, and a slot 25 at the head end, providing dumbbell eyes 30 comprised of a pair of eye shaped members 45 interconnected by an elastic member 50, followed by inserting the dumbbell eyes 30 into the slot 25 of said lure body. In one embodiment of the present invention, the eye shaped members 45 are made of an elastomeric material having a Shore OO durometer of less than or equal to 30. In another embodiment, the elastic member 50 is made from a material selected from the group comprising: elastomeric material, porous plastic, plastic, or combinations thereof. In yet another embodiment, the method further comprises the step of coating the lure body the said dumbbell eyes 30 with a layer of clear plastisol or thermoplastic elastomer to maintain the position of the eye shaped members 45 during use.

In one embodiment of the present invention, the dumbbell eyes 30 used in the above methods may be formed by injection molding. In another embodiment, the dumbbell eyes 30 may further comprise one or more color additives or colorants being selected from the group comprising: pigment, dye, color, glitter, foil, MYLAR (a polyethylene terepthalate film), holograms, mica, or combinations thereof. In yet another embodiment, the eye shaped members 45 may have one color for a pupil 35 of the eye shaped members 45, and a different color for an iris 40 of the eye shaped members 45, and wherein the colors used for the pupil 35 and/or the iris 40 being injected into the mold using a core shot method. In still another embodiment, the slot 25 may further comprise a pair of eye sockets and wherein a distance between the eye shaped members 45 can assume a first position, in which the distance between the two eye shaped members 45 is less than the distance between the pair of eye sockets in the slot 25 of the lure body, and a second position, in which the distance between the two eye shaped members 45 is greater than the distance between the pair of eye sockets in the slot 25 of the lure body, as well as a range of positions in between said first and said second positions.

The present invention also includes an improved fishing lure 10 which comprises a lure body having a head end 15, a tail end 20, and a slot 25 at the head end, wherein the improvement comprises dumbbell eyes 30 comprised of a pair of eye shaped members 45 interconnected by an elastic member 50. In one embodiment of the present invention, the eye shaped members 45 are made of an elastomeric material having a Shore OO durometer of less than 30. In another embodiment, the elastic member 50 is made from material selected from the group of: elastomeric materials, porous plastics or combinations thereof. In still another embodiment, the elastic member 50 is made of the same elastomeric material as the two eye shaped members 45. This allows the fishing lure 10 or dumbbell eyes 30 to be injection molded using a single uniform material.

The dumbbell eyes 30 may further comprise a colorant. The eye shaped members 45 and elastic member 50 may incorporate a color additive, or colorant, which is selected from the group consisting of: pigment, dye, color, glitter, foil, MYLAR (a polyethylene terepthalate film), holograms, mica, or combinations thereof. It is also possible for the colorant to be applied to the surface of the dumbbell eyes 30 by a spray, printing or direct application method such as by brush or roller. In one embodiment, the eye shaped members 45 contain a pupil 35, which is a different color than the rest of the eye shaped member. In an alternative embodiment, the eye shaped members 45 contain a circular pupil 35, surrounded by a ring-like iris 40. The pupil 35 and the iris 40 may have different colors than each other, and also different colors than the rest of the eye shaped member. These colors can be applied to the eye shaped member via one-shot injection molding, which locates the pupil 35 in the center of the iris 40 in one step.

It will be possible to attract different types of fish by using eye shaped members 45 that simulate the body parts they particularly like or by simulating the natural body parts of fish, insects or amphibians. This simulation can be enhanced by changing the size and shape of the eye shaped members, or by adding in color or attractants which simulate these natural body parts the best. In one embodiment of the invention, the size, shape, and color of the eye shaped members 45 are similar to those of real fish eyeballs. In another embodiment, the size, shape, and color of the eye shaped members 45 may resemble amphibian or reptile eyes. In yet another embodiment, the size, shape, and color of the eye shaped members 45 can be varied to take any form which would be attractive to fish.

In one embodiment of the invention, the dumbbell eyes 30 contain two eye shaped members 45 connected by an elastic member 50. In another embodiment, an improved fishing lure 10 can contain 2 or more pairs of dumbbell eyes 30. The number of dumbbell eyes 30 used in a particular lure will vary according to the needs of the fisherman and the design of the lure being used.

In one embodiment of the present invention, the eye shaped members 45 and the elastic member 50 are made of an elastomeric material which is a mixture of thermoplastic elastomer (TPE) and an oil (or plasticizer). It has been found that the use of TPE having a specific gravity of less than 0.95 in the formation of dumbbell eyes 30, eye shaped members 45, and/or elastic members 50 performs better than TPE having a specific gravity of greater than 0.95. The dumbbell eyes work well when the specific gravity is in the range of 0.76 to 0.88. Having a specific gravity which is less than water allows the dumbbell eyes 30 to float which helps in its simulation of a live fish. The lighter weight of the dumbbell eyes 30 also decreases the overall weight of the fishing lure. Alternatively, depending on the needs of the fisherman and the design of the lure, the specific gravity of the dumbbell eyes 30 may range from 0.79 through 1.15, allowing the dumbbell eyes 30 to float or sink slowly.

The elastomeric material which may be used to form the dumbbell eyes 30 is elastic, tear resistant, and soft. Their elasticity allows them to be stretched several times their original length without tearing. The dumbbell eyes 30 can flex and stretch to fit various lures, allowing easy and quick installation into the lure by first stretching and elongating the dumbbell eyes 30 followed by insertion into the lure. In one embodiment of the present invention, the dumbbell eyes 30 will stretch with the base material of the lure when the lure is coated with an outer layer of clear plastisol or thermoplastic elastomer so the dumbbell eyes 30 will not come off or become dislodged during use. The flexibility of the dumbbell eyes 30 will ensure that it does not tear off the front of a plastic lure during casting or a strike.

The elastomeric material is soft and has a Shore OO hardness less than or equal to 30. The Shore hardness is measured with an apparatus known as a durometer and consequently is also known as “durometer hardness”. The hardness value is determined by the penetration of the durometer indenter foot into the sample. Because of the resilience of rubbers and plastics, the indentation reading may change over time—so the indentation time is sometimes reported along with the hardness number. The ASTM test method designation is ASTM D2240 00 and is generally used in North America. The Shore OO is used to measure very soft compounds; harder compounds can be measured with a Shore A or Shore D durometer. Related methods include ISO 7619 and ISO 868; DIN 53505; and JIS K 6301, which was discontinued and superseded by JIS K 6253. The results obtained from this test are a useful measure of relative resistance to indentation of various grades of polymers.

In one embodiment of the present invention, the elastomeric material comprises a mixture of styrenic block copolymer and an oil, where the oil is in excess, by weight, of the copolymer. In another embodiment, the elastomeric material comprises a mixture of one or more styrenic block copolymers and at least two oils, where the oil is in excess, by weight, of the copolymer and one oil is used in excess of the other oil, by weight. In still another embodiment, the elastomeric material comprises a styrenic block copolymer and an oil mixture of a first oil and a second oil where the first oil has a viscosity that is greater than a viscosity of the second oil and the second oil is used in excess of the first oil.

Styrenic block copolymers are thermoplastic elastomers. Their structure normally consists of a block of a rigid styrene on each end with a rubbery phase in the center. Styrenic block copolymers include, but are not limited to, SBS (styrene butadiene styrene), SIS (styrene isoprene styrene), SEPS (styrene ethylene/propylene styrene), SEBS (styrene ethylene/butylene styrene), and SEEPS (styrene ethylene/ethylene propylene styrene). These materials are commercially available from, for example, SEPTON Company of America (Pasadena, Tex.), and Kraton Polymers (Houston, Tex.). Exemplary SEPTON (US) products include SEPTON 4055 (SEEPS); SEPTON 8006 (SEBS); and SEPTON 2006 (SEPS). Exemplary Kraton (US) products include KRATON 1651 (SEBS). It is possible to use just one of these polymers or a combination of these polymers. It will be known to those of ordinary skill in the art that by varying the amount of copolymer and oil one can achieve an end product having different durometer readings.

The oil or plasticizer generally refers to mineral oils or silicone (dimethyl silaxone) oil. The oil is mixed with the styrenic block copolymer. The heavier oils (i.e., greater molecular weights or greater viscosity) decreased heat deformation and processibility and increased surface tack. Such oils are commercially available from, for example, Crompton Corporation (Witco Refined Products), Greenwich, Conn. Exemplary oils include: BLANDOL white mineral oil, specific gravity @ 25° C./25° C. (ASTM D4052)-0.839/0.855; Kinematic viscosity @ 40° C., CST (ASTM D445)-14.2/17.0 (heavy oil), and SEMTOL white mineral oil, specific gravity @ 25° C./25° C. (ASTM D4052)-0.804/0.827, Kinematic viscosity @ 40° C., CST (ASTM D445)-3.9/5.5 (light oil). It may also be possible to use natural oils such as corn oil, olive oil, fish oil, or cod liver oil.

In one embodiment of the present invention, the elastomeric material is a styrenic block copolymer having a Shore OO hardness in the range of 3 to 15. In another embodiment, the elastomeric material is a styrenic block copolymer having a Shore OO hardness in the range of 4 to 12. In yet another embodiment, the elastomeric material is a styrenic block copolymer having a Shore OO hardness of less than or equal to 20. In still another embodiment, the elastomeric material is a styrenic block copolymer having a Shore OO hardness of less than or equal to 18.

One of the goals is for the dumbbell eyes 30 and the fishing lure 10 to look, feel, smell, and taste like a natural fish part or fish. The elastomeric material can be combined with other conventional additives. Such additives include: UV-stabilizer, heat-stabilizer, pigments, dyes, flavorant, attractants, and the like. The attractants can be added to the eye shaped members 45, the elastic member 50, the fishing lure 10, or any combination thereof. Examples of fish attractants include, but are not limited to, fish oil, cod liver oil, fish meal, salt, garlic or anise (licorice) scents, commercially available fish attractants, oils which may include extracts from shad, menhaden, shrimp, eel, crayfish, baitfish, worms and/or other water-oriented creatures. The active ingredients in some attractants may include, but are not limited to, extracts of garlic, anise, other plants, fruit, or seeds. Attractants may also be laced with odorless, tasteless compounds which include, but are not limited to, enzymes, hormones, and pheromones that may trigger a feeding response or other type of biological response in a fish. The materials used to manufacture any of the fish attractants previously set forth may be the by-products or remnant of some other manufacturing process such as the making of fish meal or cat food. These by products may then be pressed or further processed to extract the oils, proteins, amino acids, and/or other compounds used as fish attractants. These active ingredients are often mixed with a heavier, thicker inert base oil or gel that provides for better, longer-lasting underwater adhesion to plastic.

In one embodiment of the invention, the elastic member 50 is made from an elastic material, such as a styrenic blocked copolymer, a rubber, a spandex, or combinations thereof. In another embodiment, the elastic member 50 is made from a hard plastic, or cotton or other natural material so that it will be far less elastic. In yet another embodiment, the elastic member 50 may not stretch at all. In still another embodiment, a hook can be passed through the elastic member 50, thus not limiting where the hook can be placed. This is also an advantage for the fly fisherman tying his own flies, in that the hook will remain centered between the eyes, and not allowed to slide off center during tying or use.

In another embodiment, a plurality of eye shaped members 45 are attached by an elastic member 50. The elastic member 50 may be the same material as the eye shaped members 45 or it can be a different material selected from the group comprising: elastomeric material, styrenic blocked copolymer, rubber, porous plastics, plastic, or combinations thereof. Plastic includes, but is not limited to, materials such as nylon, polypropylene, polyethylene, polyethylene terepthalate, SPANDEX, and other polymers which can be made in line or are useful in blending with other plastic or natural fibers to be made in elastic member 50 or yarns. In one embodiment, the dumbbell eyes 30 may be manufactured by molding these strands of eye shaped members 45 to the desired lengths or they can be made in a long length and then subsequently cut to any desired length.

It should be clear that in the specification or claims the term lure used here is defined as a bait, especially an artificial one, used in fishing. One of ordinary skill in fishing will recognize that the dumbbell eyes 30 can be combined with other lure components such as, but not limited to, spinners, spoons, feathers, hooks, sinkers, weighted hooks, fake fish, or combinations thereof, to create an overall lure.

The present invention may be embodied in other forms without departing from the spirit and the essential attributes thereof, and, accordingly, reference should be made to the appended claims, rather than to the forgoing specification, as indicated in the scope of the invention.

1. A method of creating a fishing lure comprising the steps of:
providing a lure body having a head end, a tail end, and a slot at said head end;
providing dumbbell eyes comprising a pair of eye shaped members interconnected by an elastic member; and
inserting said dumbbell eyes into said slot of said lure body.

2. The method of claim 1 wherein said eye shaped members being made of an elastomeric material having a Shore OO durometer of less than or equal to 30.

3. The method of claim 1 wherein said elastic member being made from a material selected from the group comprising: elastomeric material, porous plastic, plastic, or combinations thereof.

4. The method of claim 1 further comprising the step of:
coating said lure body and said dumbbell eyes with a layer of clear plastisol or thermoplastic elastomer to maintain the position of the eye shaped members during use.

5. The method of claim 1 wherein said dumbbell eyes being formed by injection molding.

6. The method of claim 1 wherein said dumbbell eyes further comprising one or more color additives or colorants being selected from the group comprising: pigment, dye, color, glitter, foil, MYLAR (a polyethylene terepthalate film), holograms, mica, or combinations thereof.

7. The method of claim 1 wherein said slot further comprising a pair of eye sockets and wherein a distance between said eye shaped members can assume:
a first position, in which the distance between the two eye shaped members is less than the distance between the pair of eye sockets in the slot of the lure body; and
a second position, in which the distance between the two eye shaped members is greater than the distance between the pair of eye sockets in the slot of the lure body, as well as a range of positions in between said first and said second positions.

8. The method of claim 1 wherein said eye shaped members having one color for a pupil of said eye shaped members, and a different color for an iris of said eye shaped members; and
wherein said colors used for the pupil and/or the iris being injected into the mold using a core shot method.

9. An improved fishing lure comprising a lure body having a head end, a tail end, and a slot at said head end wherein the improvement comprises:
dumbbell eyes comprising a pair of eye shaped members interconnected by an elastic member; and
wherein the elastomeric material is a styrenic blocked copolymer material;
wherein said pair of dumbbell eyes being positioned within said slot of said lure body.

10. The improved fishing lure of claim 9 wherein said eye shaped members being made of an elastomeric material having a Shore OO durometer of less than or equal to 30.

11. The improved fishing lure of claim 9 wherein said elastomeric material has a specific gravity of 0.79 through 1.15, allowing a variety in the ability of said dumbbell eyes to sink or float.

12. The improved fishing lure of claim 9 wherein said elastic member being made from a material selected from the group comprising: elastomeric material, porous plastic, plastic, or combinations thereof.

13. The improved fishing lure of claim 9 wherein said dumbbell eyes being formed by injection molding.

14. The improved fishing lure of claim 9 wherein said eye shaped members further comprising one or more color additives or colorants being selected from the group comprising: pigment, dye, color, glitter, foil, MYLAR (a polyethylene terepthalate film), holograms, mica, or combinations thereof.

15. The improved fishing lure of claim 9 wherein said slot further comprising a pair of eye sockets and wherein the distance between said eye shaped members can assume:
a first position, in which the distance between the two eye shaped members is less than the distance between the pair of eye sockets in the slot of the lure body; and
a second position, in which the distance between the two eye shaped members is greater than the distance between the pair of eye sockets in the slot of the lure body, as well as a range of positions in between said first and said second positions.

16. The improved fishing lure of claim 9 wherein said eye shaped members having one color for a pupil of said eye shaped members, and a different color for an iris of said eye shaped members; and
wherein said colors used for the pupil and/or the iris being injected into the mold using a core shot method.

17. The improved fishing lure of claim 9 wherein said elastic member is made of the same material as said eye shaped member.
